(19) United States
(12) Patent Application Publication
(10) Pub. No.: US 2023/0381926 A1
(43) Pub. Date: Nov. 30, 2023

(54) ADJUSTABLE PLIER WITH DUAL ADJUST

(71) Applicant: BLACK & DECKER INC., New Britain, CT (US)

(72) Inventors: David P. Engvall, Stanley, NC (US); Pavel Dugin, Catonsville, MD (US); Nick Clontz, Mooresville, NC (US); Chris Ibrahim, Fort Mill, SC (US)

(21) Appl. No.: 18/324,064

(22) Filed: May 25, 2023

Related U.S. Application Data
(60) Provisional application No. 63/345,769, filed on May 25, 2022.

(51) Int. Cl. B25B 7/10

(52) U.S. Cl. CPC B25B 7/10

(57) ABSTRACT

A device and method for clamping an object with adjusting plier with dual mode is disclosed. In particular, a device is provided with a top jaw having a bottom handle, a bottom jaw having a top handle, a slot, and ridges located around the slot and a top handle with a distal end. A pawl pivot, which includes an engagement element, is provided for extending through the bottom jaw and into a slot of the bottom jaw. The top jaw can include a slot for receiving at least part of the bottom jaw and bottom handle. The top jaw can include an opening for operatively connecting at least part of the pawl pivot. The bottom jaw and bottom jaw pivot about an axis of the rivet, and the engagement element is moveable along the same axis from a first position to a second position and may provide ambidextrous use.

### I. CROSS-REFERENCE TO RELATED APPLICATION

This application is a non-provisional of and claims priority to U.S. Provisional Patent Application No. 63/345,769, filed on May 25, 2022, titled, “Adjustable Plier,” which is incorporated herein by reference in its entirety.

### II. FIELD OF THE INVENTION

The present invention relates generally to plier devices, and more particularly, to plier devices that can be quickly adjusted to several positions.

### III. BACKGROUND OF THE INVENTION

Adjustable pliers, as may also be called “water pump pliers” or “groove joint pliers” are common tools used by all trades. They are versatile tools for a variety of gripping, torquing, pulling, bending, etc. processes. A key feature of adjustable pliers is a wide range of jaw openings achieved by multiple positions for the pivot between the jaws.

Numerous arrangements have been developed over the years to adjust and retain the pivot between the jaws at the selected position. Traditional methods include arcuate grooves that engage between the jaws and a pivot pin with a flat side adjustable between connected circular openings. More modern examples of adjustable pliers utilize quicker and/or finer adjustment methods. Examples of a modern adjustable pliers are described in the following four patents:

U.S. Pat. No. 7,040,201 is directed toward a method and device is disclosed for clamping an object with quick adjusting pliers. A top jaw has a bottom handle, a slot, and a series of ridges located around the slot. A pin extends through the slot and includes an engagement element. A bottom jaw has a top handle and another opening for receiving the pin. The engagement element engages at least one of the series of ridges in a first position, wherein the top jaw and bottom jaw pivot about a first axis that extends through a longitudinal axis of the pin, and wherein the engagement element is moveable along the first axis from the first position to a second position wherein the engagement element does not engage any of the series of ridges.

U.S. Pat. No. 7,089,832 is directed toward a method and device is disclosed for clamping an object with quick adjusting pliers. A top jaw has a bottom handle, a slot, and a series of ridges located around the slot. A pin extends through the slot and includes an engagement element. A bottom jaw has a top handle and another opening for receiving the pin. The engagement element engages at least one of the series of ridges in a first position, wherein the top jaw and bottom jaw pivot about a first axis that extends through a longitudinal axis of the pin, and wherein the engagement element is moveable along the first axis from the first position to a second position wherein the engagement element does not engage any of the series of ridges.

U.S. Pat. No. 7,100,480 is directed toward a device and method for clamping an object with quick adjusting pliers. In particular, a device is provided with a top jaw having a bottom handle, a slot, and a series of ridges located around the slot. A pin is provided for extending through the slot. A tongue element is also provided with a first opening for receiving the pin. In addition, a bottom jaw is provided with a top handle and another opening for receiving the pin. The tongue element engages one of the series of ridges. The top jaw and bottom jaw pivot about a first axis of the pin, and the tongue element is moveable relative to the series of ridges to allow for engagement or disengagement of the ridges.

U.S. Pat. No. 7,293,485 is directed toward a device and method for clamping an object with quick adjusting pliers. In particular, a device is provided with a top jaw having a bottom handle, a slot, and a series of ridges located around the slot. A pin, which includes an engagement element, is provided for extending through the slot. In addition, a bottom jaw is provided with a top handle and another opening for receiving the pin. The top jaw and bottom jaw pivot about an axis of the pin, and the engagement element is moveable along the same axis from a first position wherein the engagement element engages at least one of the series of ridges to a second position wherein the engagement element does not engage any of the series of ridges.

While the modern adjusting pliers above provide for quick adjustment, there exists a need for an adjusting plier providing ambidextrous tool handling, finer teeth adjustment for more precision, and smaller footprint to allow for access to tighter spaces. The prior mentioned adjusting pliers lack these features. Therefore, there exists a need for an improved adjusting plier.

### IV. SUMMARY OF THE INVENTION

Pliers are generally known for gripping articles and for applying a force to an article such as a fastener. Pliers usually comprise a pair of members pivoted to one another for relative movement. Typically, one end of the members includes jaws for gripping the article and the other end of the members are formed as handles for manually applying a gripping force to the jaws and a turning force to the pliers. Mechanisms are known for adjusting the distance between the jaws to allow the jaws to grip articles of varying size. One type of mechanism allows the user to push a button or lever to release the engagement of the members from one another and to allow the jaws to be moved relative to one another to adjust the spacing. While the prior mentioned mechanism is known, an improved adjusting plier with dual mechanisms assisting in ambidextrous tool handling, finer teeth adjustment for more precision, and smaller footprint is desired.

The present invention provides a device and method for clamping an object with adjustable pliers.

In one embodiment, the plier device includes a top jaw having a bottom handle; a bottom jaw having a top handle, the bottom jaw having a plurality of spaces within said bottom jaw for receiving the top jaw and the bottom handle, a slot and a series of ridges located on at least one surface of the top jaw, wherein the series of ridges are located on at least one surface of the slot, a top handle, the top handle having distal ends, and a pawl pivot that extends through the slot, wherein the pawl pivot has on at least one surface an engagement element connected to the pawl pivot, wherein the engagement element engages at least one of the series of ridges in a first position, and wherein the engagement element is movable along a first axis from the first position to a number of second positions along the first axis to engage any of the series of ridges of the slot.

In another embodiment, the invention is an improved plier device including a bottom jaw having a top handle, the bottom jaw having a plurality of spaces within said bottom jaw for receiving the top jaw and the bottom handle, top jaw having a bottom handle, the bottom handle having a slot, the slot having a series of ridges, wherein the series of ridges are located on at least one surface surrounding the slot a pawl pivot that extends through the slot, wherein the pawl pivot has on at least one surface an engagement element on the pawl pivot, wherein the engagement element is movable along a first axis from a first position to a number of second positions along the first axis wherein the engagement element can be selectively engaged to any of the series of ridges of the slot, and wherein the pawl pivot includes at least one recess configured to house at least one of an elastic member, dowel pin, or ball bearing configured to interact with the bottom handle.

In at least one embodiment of the present invention, the invention is a dual mode adjustable plier device comprising: a top jaw having a bottom handle; a bottom jaw having a top handle, the bottom jaw having a plurality of spaces within said bottom jaw for receiving the top jaw and the bottom handle, a slot and a series of ridges, wherein the slot is located on at least part of the upper jaw and bottom handle, and wherein the series of ridges are located on at least one surface of the slot, a top handle, the top handle having an opening configured to overlap at least part of the bottom handle, and a pawl pivot that extends through the slot, wherein the pawl pivot has an engagement element on at least one surface of the pawl pivot, wherein the engagement element is movable along a first axis from a first position to a second position to engage any of the series of ridges of the slot, and wherein the pawl pivot includes at least one recess configured to house at least one of an elastic member, dowel pin, and/or ball bearing configured to interact with the top handle.

In another embodiment, the invention is an adjusting plier device including a top jaw having a slot with a series of ridges and a bottom handle, wherein the ridges are located on at least one inner surface of the slot, a pawl pivot that extends through at least one jaw, wherein at least part of the pawl pivot is configured to engage a plurality of the ridges located in the slot; a bottom jaw, the bottom jaw having an opening and a top handle, wherein the bottom jaw is a part of the adjusting plier by the pawl pivot extending from part of the bottom jaw into the slot of the bottom handle of the top jaw, and wherein the top jaw is configured to be operatively connected to the bottom jaw through a space between the bottom jaw and the top handle, an engagement element affixed to the pawl pivot, wherein the engagement element engages at least one of the series of ridges of the slot in a first position, wherein the top jaw and the bottom jaw pivot about a first axis, and wherein the engagement element is movable along the first axis from the first position to a second position wherein the engagement element does not engage any of the series of ridges of the top jaw.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the root terms “include” and/or “have”, when used in this specification, specify the presence of stated features, steps, operations, elements, and/or components, but do not preclude the presence or addition of at least one other feature, step, operation, element, component, and/or groups thereof.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

For definitional purposes and as used herein, “connected” or “attached” includes physical or electrical, whether direct or indirect, affixed or adjustably mounted. Thus, unless specified, “connected” or “attached” is intended to embrace any operationally functional connection. When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

As used herein, “substantially,” “generally,” “slightly” and other words of degree are relative modifiers intended to indicate permissible variation from the characteristic so modified. It is not intended to be limited to the absolute value or characteristic which it modifies but rather possessing more of the physical or functional characteristic than its opposite, and approaching or approximating such a physical or functional characteristic.

In the following description, reference is made to the accompanying attachments and drawings which are provided for descriptive and illustration purposes as representative of specific exemplary embodiments in which the invention may be practiced. Given the following description of the specification and drawings, the apparatus, methods, and systems should become evident to a person of ordinary skill in the art. Further areas of applicability of the present teachings will become apparent from the description and illustrations provided herein. It is to be understood that other embodiments can be utilized and that structural changes based on presently known structural and/or functional equivalents can be made without departing from the scope of the invention.

### V. DESCRIPTION OF THE DRAWINGS

The above-mentioned and other features, embodiments, and advantages of this invention, and the manner of attaining them, will become more apparent and the invention will be better understood by reference to the following descriptions of embodiments of the invention taken in conjunction with the accompanying drawings, wherein:

FIG. 1 is a perspective view of one embodiment of an Adjustable Plier.

FIG. 2 is a front view of the adjustable plier of FIG. 1.

FIG. 3 is a rear view of the adjustable plier of FIG. 1.

FIG. 4 is a top view of the adjustable plier of FIG. 1.

FIG. 5 is a bottom view of the adjustable plier of FIG. 1.

FIG. 6 is a right-side view of the adjustable plier of FIG. 1.

FIG. 7A is a left side view of the adjustable plier of FIG. 1.

FIG. 7B is a cross-sectioned, left view of the adjustable plier of FIG. 1.

FIG. 8 is a perspective, partly exploded view of the adjustable plier of FIG. 1 depicting an exemplary Pawl Pivot.

FIG. 9 is a perspective view of the exemplary pawl pivot of FIG. 8.

FIG. 10 is a rear, cross-sectioned exemplary view of the pawl pivot of FIG. 8.

FIG. 11 is a rear view of the exemplary pawl pivot of FIG. 10.

FIG. 12 is a front view of the exemplary pawl pivot of FIG. 8.

FIG. 13 is a bottom view of the exemplary pawl pivot of FIG. 8.

FIG. 14 is an exploded, perspective view of the adjustable plier of FIG. 1.

FIG. 15 is an exploded, perspective view of the adjustable plier without the pawl pivot and depicting the structural alignment of the handle grips to the plier handles.

FIG. 16 is an exploded, side view of the adjustable plier without the pawl pivot.

FIG. 17 are various views of the adjustable plier, plier handles and exemplar pawl pivot of FIG. 1

FIG. 18 is a side view of the adjustable plier of FIG. 1 in fundamental use around an object.

Corresponding illustrated images and attachments indicate corresponding parts throughout the several views of the present invention. The exemplifications set out herein illustrate embodiments of the present invention, and such exemplifications are not to be construed as limiting the scope of the present invention in any manner.

These and other features of the invention will become apparent upon review of the following description of the presently preferred embodiments of the invention, taken into conjunction with the figures.

### VI. DETAILED DESCRIPTION

A detailed description of apparatuses, methods, and systems, consistent with embodiments of the present disclosure is provided below. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

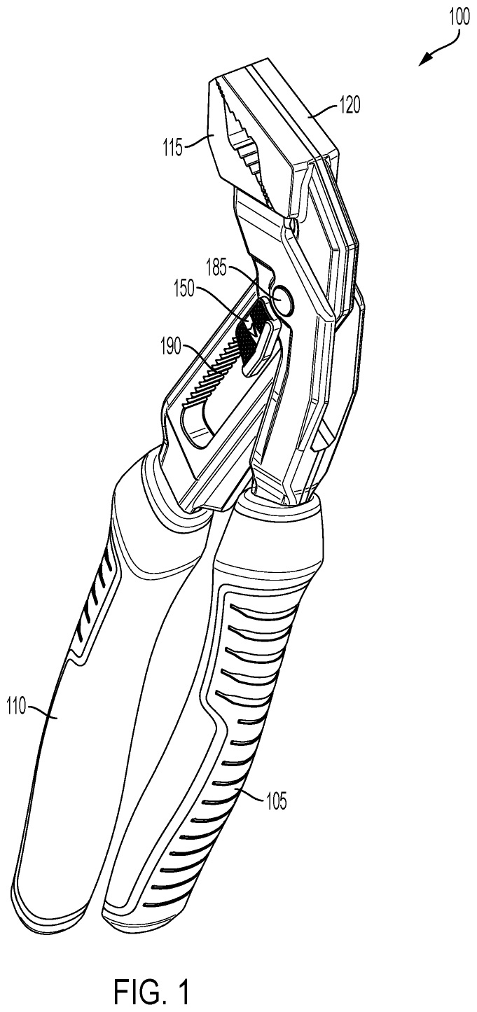

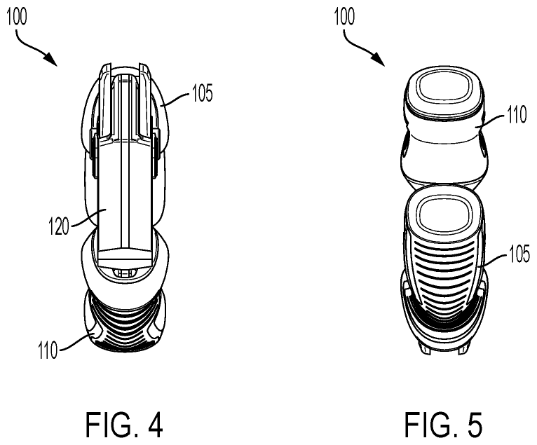

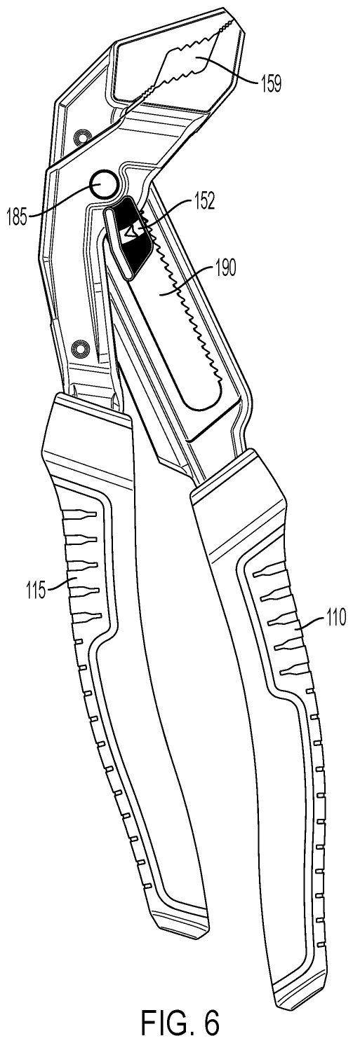

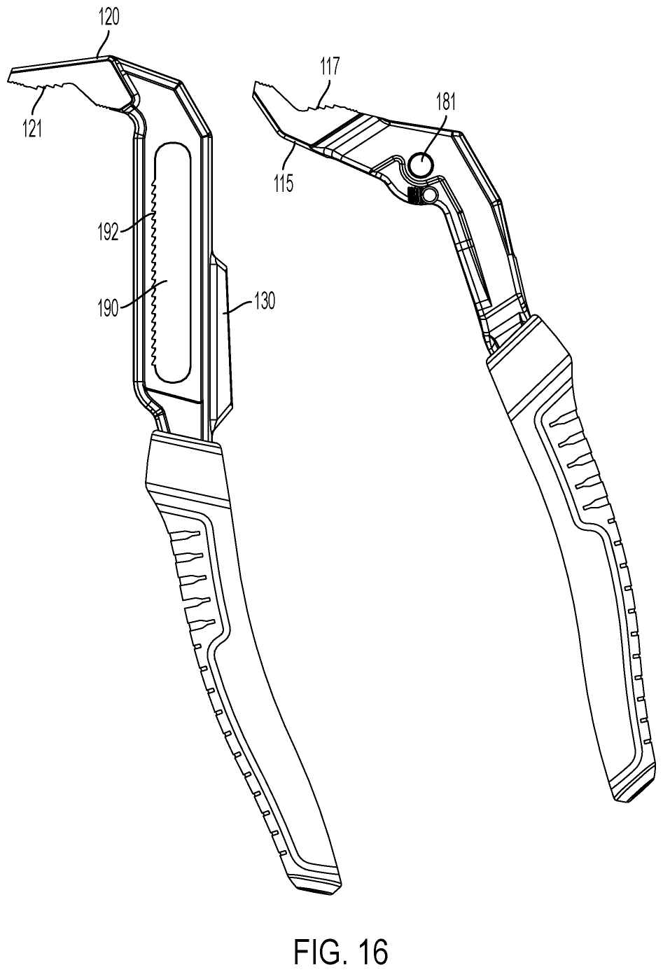

An example implementation of one embodiment of an adjustable plier 100 is shown in FIGS. 1-18. The exemplary plier tool 100 illustrated in FIGS. 1-18 is a handheld adjustable plier, simply for ease of discussion and illustration. However, the principles to be described herein may be applied to other types of handheld tools that are operable in different modes such as, for example, use of a tool without the jaw clamping function. Referring to FIG. 1, a perspective view of an embodiment in accordance with the adjustable plier device 100 of the present invention is shown.

A top jaw 120 is integrally attached to a bottom handle 110. The top jaw 120 has a slot 190 formed therein and has a series of ridges 192 formed on at least one side of the slot 190 and above the bottom handle 110. The top jaw also includes a sliding surface on the opposite face of the ridges 192.

A bottom jaw 115 is integrally attached to a top handle 105 and has an opening 181 for receiving a pin or rivet 185. The rivet 185 extends through an opening 159 of a pawl pivot 150, through the opening 181 of the bottom jaw 115 and the slot 190 of the top jaw 120. With the pawl pivot 150, rivet 185 pivotally connects the top jaw 120, bottom jaw 115.

The current invention works in similar manner of other common adjustable pliers/wrench with the adjustment accomplished by a ratcheting mechanism yet has unique advantages over the standard pliers/wrench. The usual adjustment and clamping on a work piece is accomplished by squeezing a “plier” handle or applying a force on a handle forcing the parallel jaws together.

A mechanical advantage of the current plier invention over other pliers are this current plier inventions provides different modes of force applied for operating the opening and closing the plier jaws 115, 120. The current plier tool 100 has this added functionality of dual modes wherein the quick and/or easy adjustment of tool occurs wherein the jaws 115, 120 can be moved closer together by ratcheting or acting on the adjusting mechanism by applying a force on at least one plier handle without pushing a button. The current plier tool 100 has the additional functionality of quick and/or easy adjusting wherein the jaws 115,120 can be moved further apart by applying a force on a pawl pivot 150 and manipulating said pawl pivot 150 along an axis to or away from the top jaw 120. Additional modes include easy adjustment by a force acting on the pawl pivot 150 to the move the pawl pivot 150 from a first position to a number of second positions. The current plier tool 100 also provides for ambidextrous hand use by a plier device 100 user.

Generally, the adjustable plier device 100 consists of the top jaw 120 and a bottom jaw 115 connected by the pawl-pivot 150 and a rivet 185, the pawl-pivot 150 being biased by at least one of an elastic member, such as a spring, dowel, shoe, and/or ball bearing. In this embodiment, the top jaw 120 and may be compositely one part along with the bottom handle 110 and the bottom jaw 115 may be compositely one part along with the top handle 105.

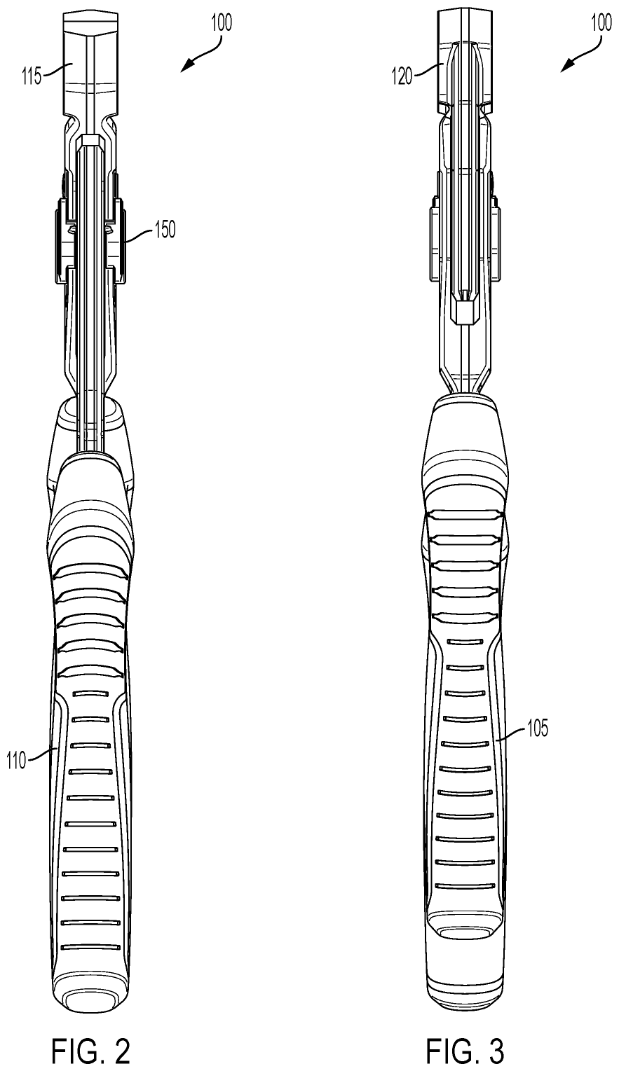

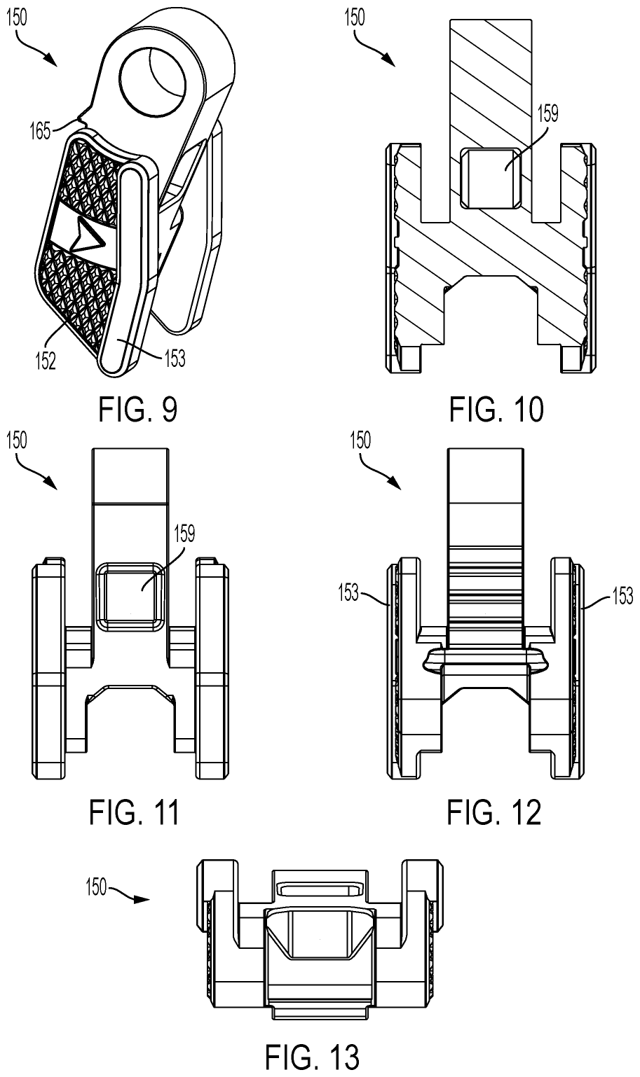

FIGS. 2-6 illustrate the structure and shape of plier device 100 from various views. Rivet 185 includes an extending portion 186 that extends through slot 190 of the top jaw 120, the pawl pivot 150 and opening 181 of the bottom jaw 115. The extending portion 186 of the rivet 185 keeps the pawl pivot 150 aligned with the top jaw 120. One or more teeth or engagement element 165 (see FIG. 9) are provided on pawl pivot 150 for engaging one or more of the series of ridges 192 of the slot 190. In order to promote translation of the pawl pivot 150 and bottom jaw 115 towards the top jaw 120, ridges 192 are angled towards top jaw 120 while the engagement elements 165 are angled away or downward from top jaw 120. The pawl pivot 150 and bottom jaw 15 are thus able to freely translate towards the top jaw 20 while being prevented by the ridges 192 from translating away from the top jaw 20. Accordingly, the pawl pivot 150 is moveable relative to the ridges 192 to allow for engagement or disengagement with said ridges 192.

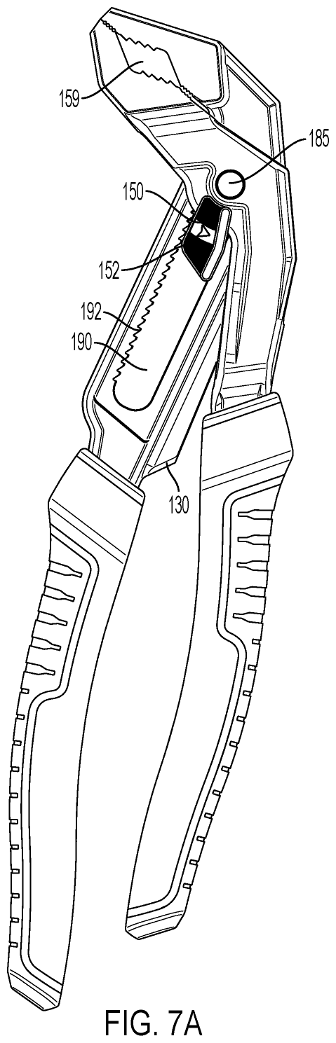

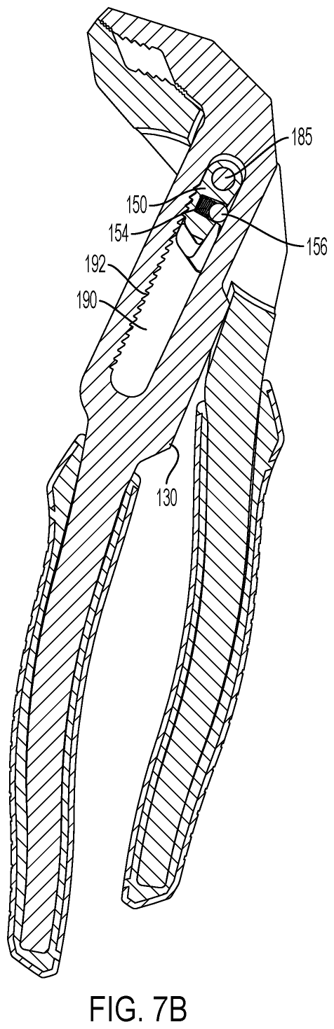

FIGS. 7A-7B illustrate various views of the plier 100. The plier 100 includes additional structure of a wedge 130 that is located on an outer surface of the top jaw 120/bottom handle 105 and adapted to stop movement or assist in closure of the jaws 115, 120 when there is not an object within the plier jaws.

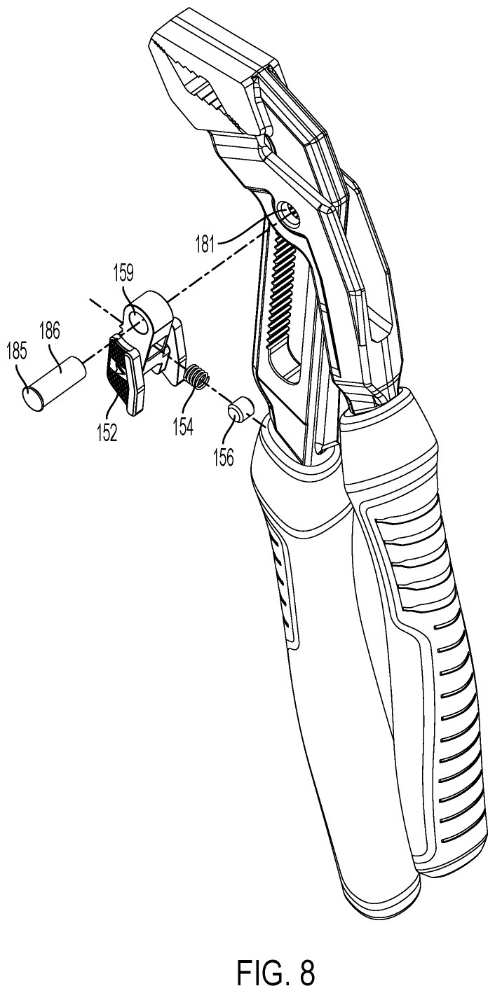

As shown in FIG. 8, there is a partly exploded view of the adjustable plier 100 of FIG. 1 depicting an exemplary pawl pivot 150. The pawl pivot 150 has teeth 165, a sliding shoulder 167, a pivot hole 159, a pocket, recess, or opening adapted to receive at least one elastic member 154, such as a spring pocket and tactile surface(s) 152, 153 (see FIG. 9). The pawl-pivot is assembled in at least one of being inside of both top jaw 120 and bottom jaw 115. When forced is placed on the pawl pivot 150 or the top handle 107, the teeth 165 can engage or disengage with the ridges 192 of the slot 190. Thus, pawl pivot 150 pivots about a second axis that is perpendicular to the first axis so that bottom jaw 115 can move away from top jaw 120 and release or compress on an object. This allows the bottom jaw 115 to freely move towards or away from top jaw 120 to provide either a smaller or larger opening between the jaws 115, 120 of the plier device 100.

FIGS. 9-13 illustrate various views of the exemplary pawl pivot 150. The pawl-pivot 150 teeth 165 can be disengaged by manipulating the tactile surface(s) 152 (grippable surface) or 153 (protruding element) aft (see FIG. 9). In at least one embodiment of the pawl pivot 250, there may be additional tactical surfaces and/or directional indicators to provide directional use of the plier 100. The pawl-pivot 150 teeth 165 can also be disengaged from any of the ridges 192 of the top jaw 120/bottom handle 109 by rotating the bottom jaw 115/top handle 107 fully open. When the pawl-pivot teeth are disengaged, the elastic member 154 is compressed by the shoe sliding 167 on an inside surface of the top jaw slot 190.

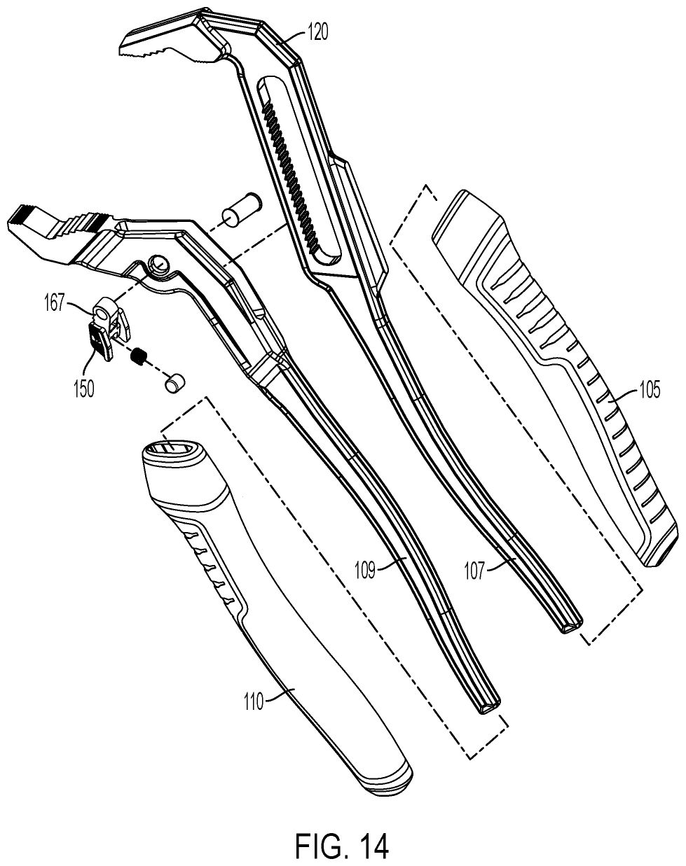

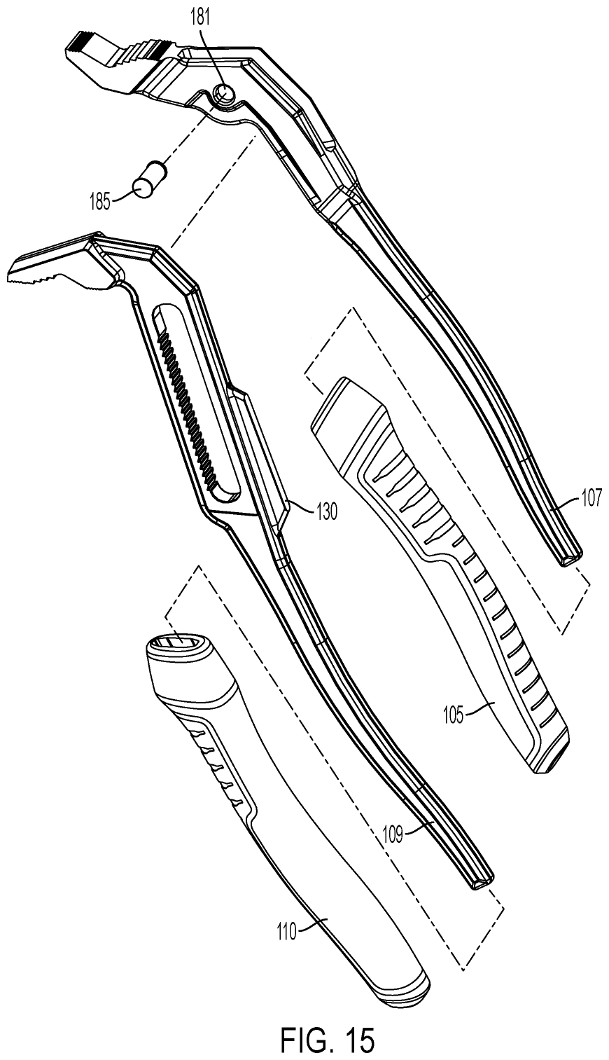

FIGS. 14-16 illustrates exploded, perspective views of the adjustable plier 100 and depicting the structural alignment of the handle covers to the plier handles. FIG. 14 also illustrates the structural and/or operational alignment or coupling of the top jaw 120/bottom handle 110, bottom jaw 115/top handle 105, pawl pivot 150, rivet 185 and jaws 115, 120. As shown in FIG. 15, there is depicted an exploded, perspective view of the adjustable plier without the pawl pivot and depicting the structural alignment of the handle grips to the plier handles. Illustrated in this Figure is a bar handle 107, a bar grip 105, bar handle 109, and bar grip 110. The bar grip 105 and bar grip 110 is used to provide additional traction and gripping surface to the functional tool. The bar grip 105 and bar grip 110 can be any suitable material, such and including, plastic, rubber, durable or variation of a polypropylene material. Frequently used and understood for functionality purposes, the bar handle 107 and bar grips 105 combined are operationally the top handle 105. Similarly, frequently used and understood for functionality purposes, the bar handle 109 and bar grips 110 are the bottom handle 110. While it is understood that bar handle 109 and bar grips 110 are compositely the bottom handle 110, it should not be construed as limited to the embodiments set forth herein and the plier tool 100 can operate without the bar grips materials, such as polypropylene.

In order for the jaws of the device to clamp an object, the teeth 165 of pawl pivot 150 engage ridges 192 that corresponds to the size of the object being clamped. Bottom jaw 115 then pivots about pin or rivet 185, which is transitionally fixed due to the engagement between the teeth 165 of the pawl pivot 150 and the correct ridge 192. When there is no object to be gripped and top jaw 120 and bottom jaw 115 contact one another, the tool 100 can stay in this position, which allows for easy storage.

Operably, the adjustable pliers 100, may quickly and easily adjust the pawl-pivot 150 or at least one of the top handle 105 or the bottom handle 110 to provide the desired jaw spacing. A wide range of object sizes and shapes can be grasped, compressed and/or torqued by the jaws 120, 115 of the plier 100. Adjusting the jaw spacing from a larger opening to a smaller opening can be accomplished quickly by ratcheting the pawl-pivot 150 closer to the top jaw 120. Adjusting the jaw spacing from a smaller to a larger opening is accomplished by disengaging the pawl-pivot 150 teeth 165 from the ridges 192 in the top jaw 120 slot 190, in one of two different methods as described above.

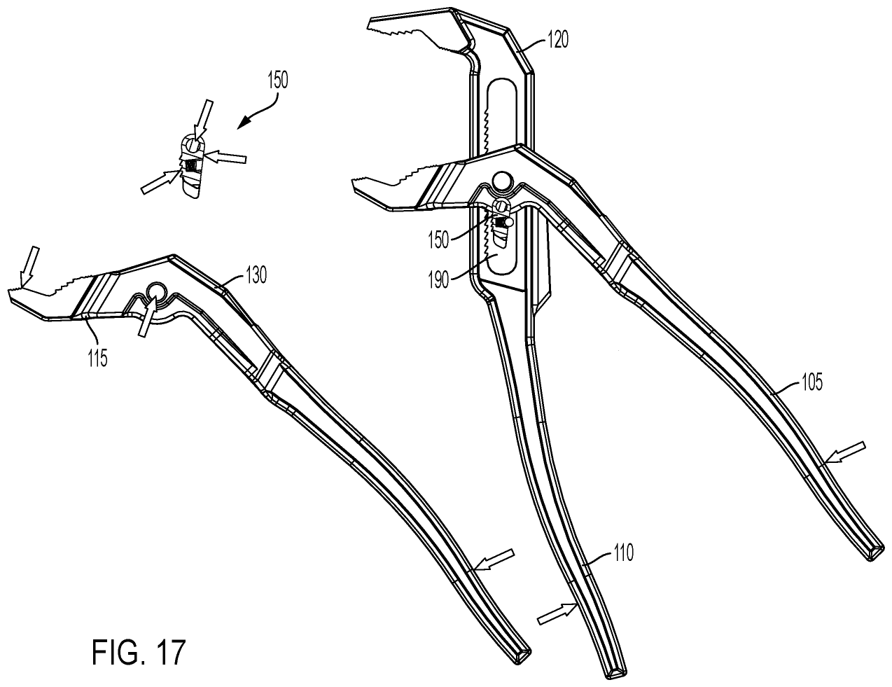

FIG. 17 illustrates various views of the adjustable plier 100, plier handles 110, 105 and exemplary pawl pivot 150 of FIG. 1 illustrating the forces (with directionals arrows) on the pawl-pivot 150 resulting from a force applied on at least one of the pawl pivot 150 or one of bottom handle 110 or top handle 105. Specifically, the plier 100 pawl-pivot 150 design facilitates all the above advantages. This description includes two loading cases for the plier tool 100, “Compressing” and “Torquing.”

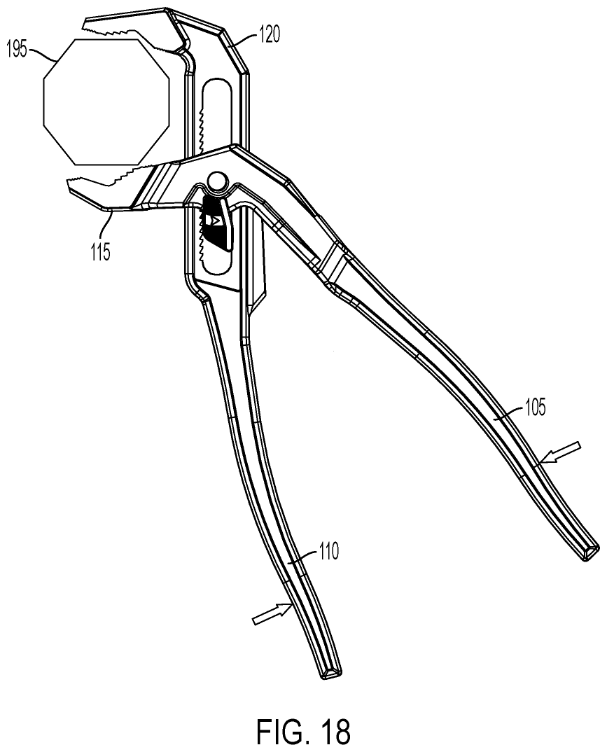

FIG. 18 compressing an object 195 or pipe-like workpiece produces a force down and to the left from the rivet 185 on the pawl-pivot. By Torquing a pipe-like workpiece produces a force down and to the right from the rivet 185 on the pawl-pivot 150. A “Positive Engagement” force from Compressing and/or Torquing is beneficial to the plier 100 design and structure allowing the adjustment ridges 192 to have a very small pitch and eliminating the need for undercut geometry, while producing reliable teeth 165 engagement with the ridges 192. The teeth 165 of the pawl-pivot are positively engaged with the ridges in the top jaw slot 190 when the jaw is loaded in compression and/or torquing, such as shown in cross-sectioned view in FIG. 7B. The teeth 165 of the pawl pivot 150 can be disengaged by either method of force on at least one of the pawl-pivot 150 (see FIG. 17) or at least one of the bottom handle 110 or the top handle 105. It is to be understood that persons of skilled in the art of this particular category would understand the application of force on a tool handle.

The example and alternative embodiments described above may be combined in a variety of ways with each other. It should be noted that the present invention may, however, be embodied in many different forms and should not be construed as limited to the embodiments set forth herein; rather, the embodiments set forth herein are provided so that the disclosure will be thorough and complete, and will fully convey the scope of the invention to those skilled in the art. Furthermore, the steps and number of the various steps illustrated in the figures may be adjusted from that shown. The accompanying figures and attachments illustrate exemplary embodiments of the invention.

Although the present invention has been described in terms of particular example and alternative embodiments, it is not limited to those embodiments. Alternative embodiments, examples, and modifications which would still be encompassed by the invention may be made by those skilled in the art, particularly in light of the foregoing teachings.

Those skilled in the art will appreciate that various adaptations and modifications of the example and alternative embodiments described above can be configured without departing from the scope and spirit of the invention. Therefore, it is to be understood that, within the scope of the appended claims, the invention may be practiced other than as specifically described herein.

What is claimed is:

1. A plier device comprising:
a top jaw having a bottom handle;
a bottom jaw having a top handle, the bottom jaw having a plurality of spaces within said bottom jaw for receiving the top jaw and the bottom handle;
a slot and a series of ridges located on at least one surface of the top jaw, wherein the series of ridges are located on at least one surface of the slot;
a top handle, the top handle having distal ends; and
a pawl pivot that extends through the slot, wherein the pawl pivot has on at least one surface an engagement element connected to the pawl pivot, wherein the engagement element engages at least one of the series of ridges in a first position, and wherein the engagement element is movable along a first axis from the first position to a number of second positions along the first axis to engage any of the series of ridges of the slot.

2. The plier device of claim 1, wherein the pawl pivot includes at least one recess configured to house at least one of an elastic member, dowel, pin, shoe, and/or ball bearing configured to interact with the bottom handle.

3. The plier device of claim 1, further comprising:
the engagement element can be disengaged or engaged with the ridges by either force on at least one surface of the pawl pivot or force on at least one of the bottom handle or the top handle.

4. The plier device of claim 1, wherein an opening between the top jaw and lower jaw can be made smaller or larger by applying force on at least one surface of the pawl pivot or force on at least one of the bottom handle or the top handle to move the bottom jaw toward or away from the top jaw.

5. The plier device of claim of 1, further comprising:
the pawl pivot having a recess on at least one surface, each recess of the pawl pivot can be one of circular, rectangular, oval, or any polygonal shape adapted to house at least one of an elastic member, dowel pin, and/or ball bearing configured to operate within a recess of the pawl pivot and against a surface of at least a portion of at least one jaw handle.

6. The plier device of claim 1, wherein the pawl pivot is configured to abut against a surface of at least a portion of at least one jaw handle during opening of at least one plier handle.

7. The plier device of claim 1, wherein at least part of the bottom handle includes a protruding wedge configured to stop movement of at least part of the top handle.

8. The plier device of claim 1, further comprising:
a force applied on at least one of one plier handle or the pawl pivot transfers said force onto or away from the ridges of the slot and along the first axis.

9. An improved plier device comprising:
a bottom jaw having a top handle, the bottom jaw having a plurality of spaces within said bottom jaw for receiving the top jaw and the bottom handle;
a top jaw having a bottom handle, the bottom handle having a slot;
the slot having a series of ridges, wherein the series of ridges are located on at least one surface surrounding the slot;
a pawl pivot that extends through the slot, wherein the pawl pivot has on at least one surface an engagement element on the pawl pivot, wherein the engagement element is movable along a first axis from a first position to a number of second positions along the first axis wherein the engagement element can be selectively engaged to any of the series of ridges of the slot, and wherein the pawl pivot includes at least one recess configured to house at least one of an elastic member, dowel pin, or ball bearing configured to interact with the bottom handle.

10. The improved plier device of claim 9, further comprising:
the engagement element can be disengaged or engaged with the ridges by either force on at least one surface of the pawl pivot or force on at least one of the bottom handle or the top handle.

11. The improved plier device of claim 9, wherein an opening between the top jaw and lower jaw can be made smaller or larger by applying force on at least one surface of the pawl pivot or force on at least one of the bottom handle or the top handle to move the bottom jaw toward or away from the top jaw.

12. The improved plier device of claim 9, wherein each recess of the pawl pivot can be one of circular, rectangular, oval, or any polygonal shape adapted to house at least one of an elastic member, dowel pin, and/or ball bearing configured to operate within a recess of the pawl pivot and against a surface of at least a portion of at least one jaw handle.

13. The improved plier device of claim 9, wherein the pawl pivot is configured to abut against a surface of at least a portion of at least one jaw handle during opening of at least one plier handle.

14. The improved plier device of claim 9, wherein the engagement element engage with ridges of the slot in a first position, and wherein the engagement element is disengaged from ridges of the slot during force acting at least one of the pawl pivot and/or a handle, and wherein the engagement element is reengaged with at least one second position ridge position when force is reduced or stopped.

15. The improved plier device of claim 9, wherein at least part of the bottom handle includes a protruding wedge configured to stop movement of at least part of the top handle.

16. The improved plier device of claim 9, further comprising:
force applied on at least one of a plier handle and/or or the pawl pivot, wherein the force transfers the engagement element onto or away from the ridges of the slot and the pawl pivot along the first axis.

17. A dual mode adjustable plier device comprising:
a top jaw having a bottom handle;
a bottom jaw having a top handle, the bottom jaw having a plurality of spaces within said bottom jaw for receiving the top jaw and the bottom handle;
a slot and a series of ridges, wherein the slot is located on at least part of the upper jaw and bottom handle, and wherein the series of ridges are located on at least one surface of the slot;
a top handle, the top handle having an opening configured to overlap at least part of the bottom handle; and
a pawl pivot that extends through the slot, wherein the pawl pivot has an engagement element on at least one surface of the pawl pivot, wherein the engagement element is movable along a first axis from a first position to a second position to engage any of the series of ridges of the slot, and wherein the pawl pivot includes at least one recess configured to house at least one of an elastic member, dowel pin, and/or ball bearing configured to interact with the top handle.

18. The dual mode adjustable plier device of claim 17, further comprising:
the engagement element can be disengaged or engaged with the ridges by either force on at least one surface of the pawl pivot or force on at least one of the bottom handle or the top handle.

19. The dual mode adjustable plier device of claim 17, wherein the pawl includes a substantially H shaped structure configured to move along an axis to a number of different positions.

20. The dual mode adjustable device of claim 17, further comprising a force applied on at least one of one plier handle or the pawl pivot transfers said force onto or away from the ridges of the slot and along the first axis.
